(19) United States
(12) Patent Application Publication
(10) Pub. No.: US 2016/0314554 A1
(43) Pub. Date: Oct. 27, 2016

(54) EVACUATION PLAN DESIGN

(71) Applicant: NATIONAL ICT AUSTRALIA LIMITED, Eveleigh, New South Wales (AU)

(72) Inventors: Victor PILLAC, Eveleigh, NSW (AU); Pascal VAN HENTENRYCK, Eveleigh, NSW (AU); Caroline EVEN, Eveleigh, NSW (AU)

(21) Appl. No.: 14/896,617

(22) PCT Filed: Jul. 1, 2014
(86) PCT No.: PCT/AU2014/050104

§ 371 Date: Dec. 7, 2015

(30) Foreign Application Priority Data
Jul. 2, 2013 (AU) 2013902454

(51) Int. Cl. G06Q 90/00; G01C 21/34

(52) U.S. Cl. CPC G06Q 90/205; G01C 21/3407

(57) ABSTRACT

This disclosure relates to planning movement of multiple groups over a transport network, for example, but not limited to, the evacuation of persons from geographical zones. A processor receives an initial set of paths for the multiple groups to move through the transport network to respective arrival locations and for each group an initial path to the respective arrival location and an initial departure schedule. The processor then determines based on the initial departure schedules and initial paths one or more critical groups that violate a movement performance threshold and further determines based on the transport network an updated set of paths by adding one or more paths for each critical group to the initial set of paths. Finally, the processor determines for each group an updated path to the arrival location and an updated departure schedule based on the updated set of paths.

### CROSS-REFERENCE TO RELATED APPLICATIONS

The present application claims priority from Australian Provisional Patent Application No 2013902454 Filed on 2 Jul. 2013, the content of which is incorporated herein by reference.

### TECHNICAL FIELD

This disclosure relates to planning movement of multiple groups over a transport network, for example, but not limited to, the evacuation of persons from geographical zones.

### BACKGROUND

Natural and man-made disasters, such as hurricanes, floods, and bushfires, affect numerous populated areas and may endanger the lives and welfare of entire populations. Evacuation orders are some of the most important decisions performed by emergency services: they ensure the safety of people at risk by instructing them to evacuate the threatened region, be it a building (e.g., fire), a neighbourhood (e.g., industrial hazard), or a whole region (e.g., flood). Evacuation planning also arises at strategic, tactical, and operational levels. At a strategic level the goal is to design evacuation plans for specific areas and possible threats (e.g., evacuation plans for the surroundings of a nuclear power plant). At a tactical level, the goal is to design evacuation plans for an area facing an incoming threat (e.g., evacuation of a flood plain following high precipitations). Finally, at the operational level, the goal is to schedule an evacuation, possibly adjusting the evacuation plan in real-time as the disaster unfolds.

When disasters strike over a large and populated area, large numbers of persons need to be evacuated over a transport network. The road network is typically changing by the influence of the disaster and the evacuation itself, with for instance flooded roads or accidents. Due to these dynamic changes, the evacuation plan ideally needs to be continuously re-evaluated during the disaster within tight time constraints.

However, the number of paths from one node to another in a transport network grows exponentially with the number of edges, that is, roads. Any method that scales linearly with the number of possible paths; such as enumerating each possible path, quickly becomes infeasible as a result of the large number of paths. In addition, existing methods rely on the simplifying assumption that evacuees can flow freely in the network, which is not applicable in practice. It is therefore difficult to design an evacuation plan for a substantial area using existing methods.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### DISCLOSURE OF INVENTION

A method for planning movement of multiple groups over a transport network comprises:
receiving an initial set of paths for the multiple groups to move through the transport network to respective arrival locations;
receiving for each group an initial path to the respective arrival location and an initial departure schedule;
determining based on the initial departure schedules and initial paths one or more critical groups that violate a movement performance threshold;
determining based on the transport network an updated set of paths by adding one or more paths for each critical group to the initial set of paths; and
determining for each group au updated path to the arrival location and an updated departure schedule based on the updated set of paths.

It is an advantage that, based on an initial solution, critical groups are determined and paths are added for the critical groups to determine an updated solution. As a result, the paths are added ‘on-demand’ and a movement plan can he designed without considering all possible paths. The method was applied to large-scale flood scenarios in the Hawkesbury-Nepean floodplain (Northwest of Sydney, Australia) which require evacuating in the order of 70,000 persons. Computational results show that the proposed approach is able to design evacuation plans for such large-scale scenarios in under 30 seconds, contrary to other multi-commodity flow approaches which do not scale to this problem size. Of particular interest is the fact that the proposed approach reduces the number of variables from 4,500,000 in a mixed integer programming (MIP) formulation to 30,000 in the case study.

The movement may be an evacuation and the transport network may be a road network.

Each of the multiple groups may comprise multiple group members and for each of the multiple groups the initial path and updated path may be the same for all members of that group.

It is an advantage that the paths are the same for all members of that group. As a result, entire zones are evacuated in the same fashion: The evacuees go to the same evacuation node and they take the same path. This delivers a result that is in line with what emergency services desire and is also more practical in scheduling and evaluating the efficiency of evacuations.

Each of the multiple groups may be associated with a geographical zone and the initial path and the updated path may start from the geographical zone of the respective group.

The method may further comprise repeating the steps of determining the critical groups, determining the updated set of paths and determining the updated departure schedule and updated path to iteratively optimise the updated departure schedule and the updated path.

To iteratively optimise may comprise to maximise a flow of group members to the arrival locations.

To iteratively optimise may be such that the updated departure schedule and the updated path satisfy one or more constraints.

The one or more constraints may be defined by multiple variables, such that the number of variables is based on the number of paths in the updated set of paths.

It is an advantage that the number of variables in the constraints is based, on the number of paths, such as one flow variable per path, and not on the number of edges. This is possible since the groups move through the transport network over the paths and therefore, the flow is the same on all edges on one path. As a result, the number of variables and therefore the computational complexity is reduced compared to solutions where the number of variables is based on the number of edges.

The one or more constraints may be defined by one or more variables for each of multiple time steps.

Determining the updated departure schedule and the updated set of paths may comprise simultaneously determining the updated departure schedule and the updated set of paths.

Simultaneously determining the updated departure schedule, and the updated path may comprise solving a mixed integer programming problem.

The mixed integer programming problem may be based on a flow of group members as a continuous variable.

Determining the critical groups comprises simulating the movement over the initial paths of the multiple groups based on the respective initial departure schedules.

The method may further comprise:
receiving events related to the transport network;
determining an updated transport network based on the events; and
performing the method of any one of the preceding claims based on the updated transport network.

Adding one or more paths for each critical group may comprise determining the one or more paths by solving a multiple-origin multiple-destinations shortest path problem.

Determining the one or more critical groups may comprise determining the one or more critical groups based on an initial configuration of the transport network, and the method may further comprise determining an updated network configuration.

Determining the updated departure schedule, the updated path and the updated network configuration may comprise simultaneously determining the updated departure schedule, the updated path and the updated network configuration.

It is an advantage that the updated network configuration decisions is determined simultaneously with the determination of the updated departure schedule and the updated paths as the decisions are informed by the movements of groups on the network.

The initial set of paths and the updated set of paths may comprise multiple edges and the initial network configuration and the updated network configuration may comprise configuration data indicative of whether one or more of the multiple edges is configured to allow contraflow.

The initial set of paths and the updated set of paths each may comprise two edges in opposite direction between each of multiple nodes and the configuration data may be indicative of whether one of the two edges is configured to allow contraflow.

Software, that when installed on a computer causes the computer to perform the above method.

A computer system for planning movement of multiple groups over a transport network comprises:
a first input port to receive an initial set of paths for the multiple groups to move through the transport network to respective arrival locations
a second input port to receive for each group an initial departure schedule and an initial path to the respective arrival location; and
a processor
   to determine based on the initial departure schedules and initial paths one or more critical groups that violate a movement performance threshold,
   to determine based on the transport network an updated set of paths by adding one or more paths for each critical group to the initial set of paths, and
   to determine for each group an updated departure schedule and an updated path to the arrival location based on the updated set of paths.

Optional features described of one of the above aspects of method, software or system, where appropriate, similarly apply to the other aspects also described here.

### BRIEF DESCRIPTION OF DRAWINGS

An example will be described with reference to

FIG. 1 illustrates a computer system for planning movement of multiple groups over a transport network.

FIG. 2a illustrates a method for planning evacuation movement of multiple groups from respective geographical zones over a transport network.

FIG. 2b illustrates the method of FIG. 2a as pseudo code.

FIG. 3a illustrates, a general evacuation scenario.

FIG. 3b illustrates a graph representing the evacuation scenario of FIG. 3a.

FIG. 4 illustrates a temporal discretisation of the graph FIG. 3b over the planning horizon.

FIG. 5 depicts the structure of the master scheduling problem.

FIG. 6a illustrates a map of the geographical area of interest.

FIG. 6b illustrates an evacuation graph corresponding to the map in FIG. 6a.

### BEST MODE FOR CARRYING OUT THE INVENTION

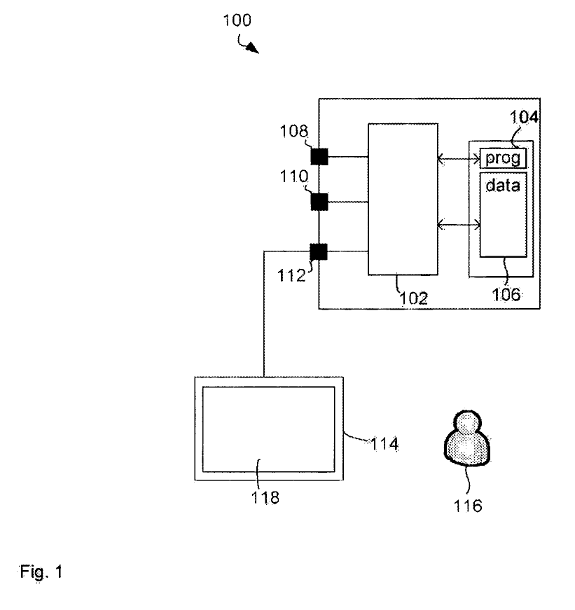

FIG. 1 illustrates a computer system 100 for planning movement of multiple groups over a transport network. The computer system 100 includes a processor 102 connected to a program memory 104, a data memory 106, first data port 108 and second data port 110. The first data port 108 and the second data port 110 may be the same data port. The processor is also connected to a user port 112 that interfaces the processor 102 with a display 114 operated by a central decision maker 116. In one example, the program memory 104 is a non-transitory computer readable medium, such as a hard drive, a solid-state disk or CD-ROM.

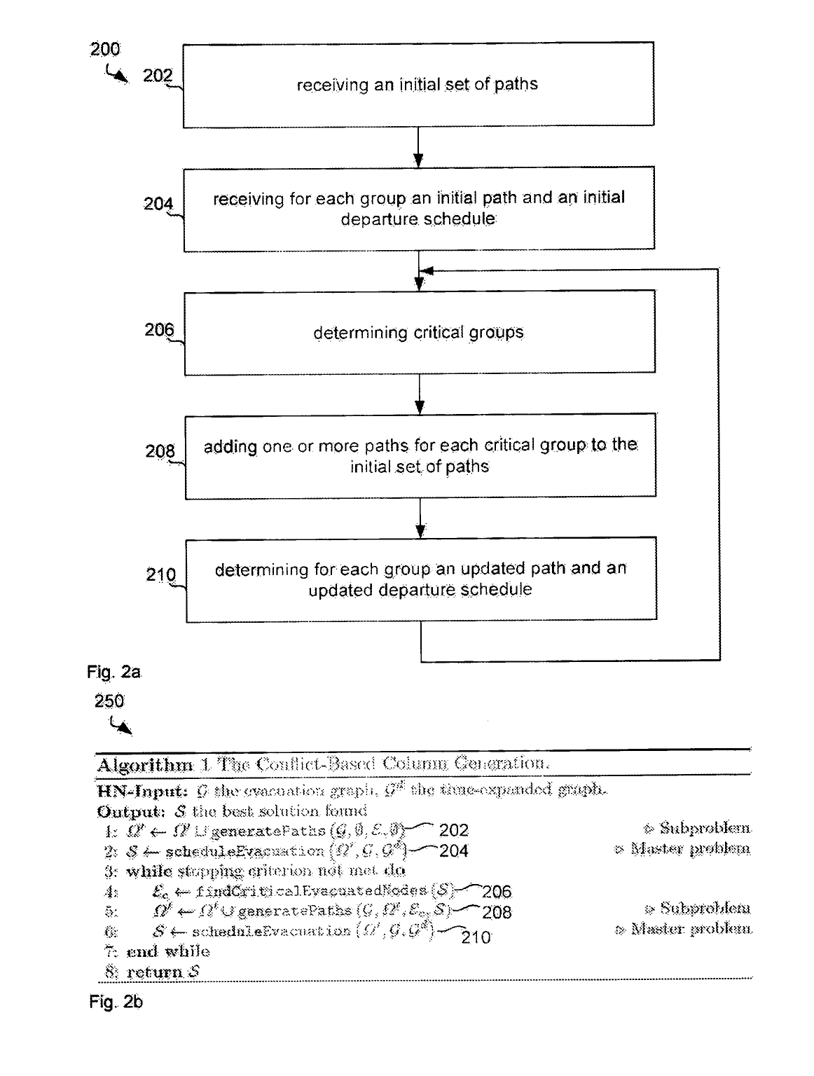

Software, that is an executable program comprising computer executable instructions, stored on program memory 104 causes the processor 102 to perform the method in FIG. 2, that is, the processor determines critical groups, adds one or more paths for each critical group to an initial set of paths, and determines for each group a departure schedule and a path to the arrival location as explained with reference to FIG. 2. The software stored on program memory 104 turns the computer system 100 into a practical movement-planning tool.

It is to be understood that any kind of data port may be used to receive and send data, such as a network connection, a memory interface, a pin of the chip package of processor 106, or logical ports, such as IP sockets or parameters of functions stored on program memory 110 and executed by processor 106. These parameters may be handled by-value or by-reference in the source code. The processor 106 may receive data through all these interfaces, which includes memory access of volatile memory, such as cache or RAM, or non-volatile memory, such as an optical disk drive, hard disk drive, storage server cloud storage.

For example, the processor 102 may pre-determine the initial set of paths, such as by selecting the shortest path, and store the initial set of path on datastore 106, such as in a database or on a RAM. The processor 102 can then request the initial set of paths from the datastore 106 and receives the initial set of paths via a memory interface.

The same applies when the processor 102 determines a path and a departure schedule. After the actual computation, the processor stores die result on a RAM, database or processor register and then receives the data directly afterwards or at a later stage via a memory interface.

In some examples, the processor 102 generates a graphical user interface 118, such as a map view, and causes the graphical user interface 118 to be displayed on display device 114 by sending appropriate commands and data to the display device 114. The central decision maker 116 can view the user interface and plan the movement accordingly.

The following examples relate to an evacuation scenario where the groups are defined by geographical zones and comprise evacuees that are located in the respective geographical zone. Geographical zones may be postcode areas, settlements or defined by a segmentation of an entire evacuation area, such as by an overlying grid. An example of a natural disaster could be a flooding event of the Hawkesbury-Nepean river northwest of Sydney, Australia, triggering a large scale evacuation. In this scenario, the evacuation zone or group of the town of Windsor, for example, may be addressed by the respective postcode, such as ‘zone 2765’. In this example, the transport network is the road network defined by the roads in the evacuation area as displayed on a road map. A ‘path’ for this group starts at this geographical zone and ends at a safe node or zone.

In other examples, the scenario is a movement of troops or movement of groups of vehicles over a transport network. In yet another example, the scenario is an evacuation, of a building, such as a high riser. In this example, the levels of the building may define the groups such that all evacuees of one level form one group. In these examples, each group has multiple members, such as military personnel, evacuees, or vehicles.

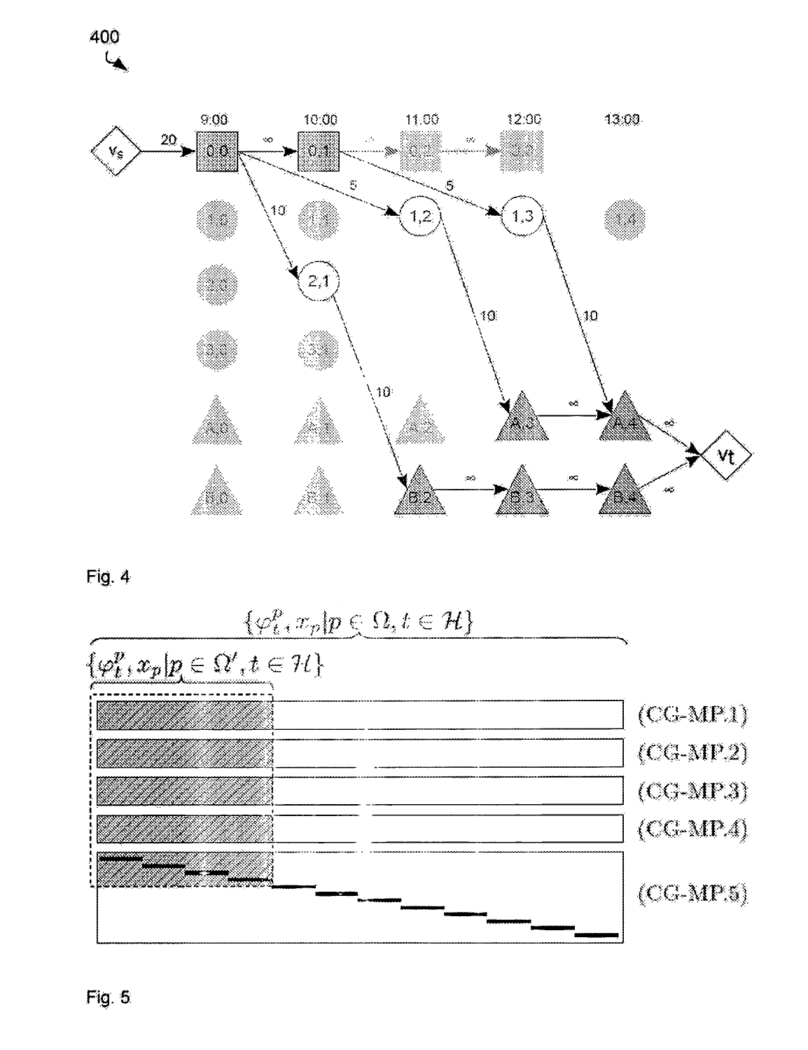

In one example of the proposed evacuation planning method, there is a dependency between paths in a time-expanded network as will be explained later with reference to FIG. 4. More precisely, a commodity (i.e., all evacuees from a specific evacuated node) can only follow paths that correspond to the same physical path (sequence of edges in the transport network). Therefore network flow approaches cannot be applied directly, as they assume that each flow unit (evacuee) can flow freely in the graph.

FIG. 2a illustrates a method 200 for planning evacuation movement of multiple groups from respective geographical zones over a transport network. FIG. 2 is to be understood as a blueprint for the evacuation planning software program and may be implemented step-by-step, such that each step in FIG. 2 is represented by a function in a programming language, such as C++ or Java. The resulting source code is then compiled and stored as computer executable instructions on program memory 104.

FIG. 2b illustrates the method 200 of FIG. 2a as pseudo code 250 such that the same reference numerals in FIG. 2a are used for step in method 200 as well as lines in pseudo code 250.

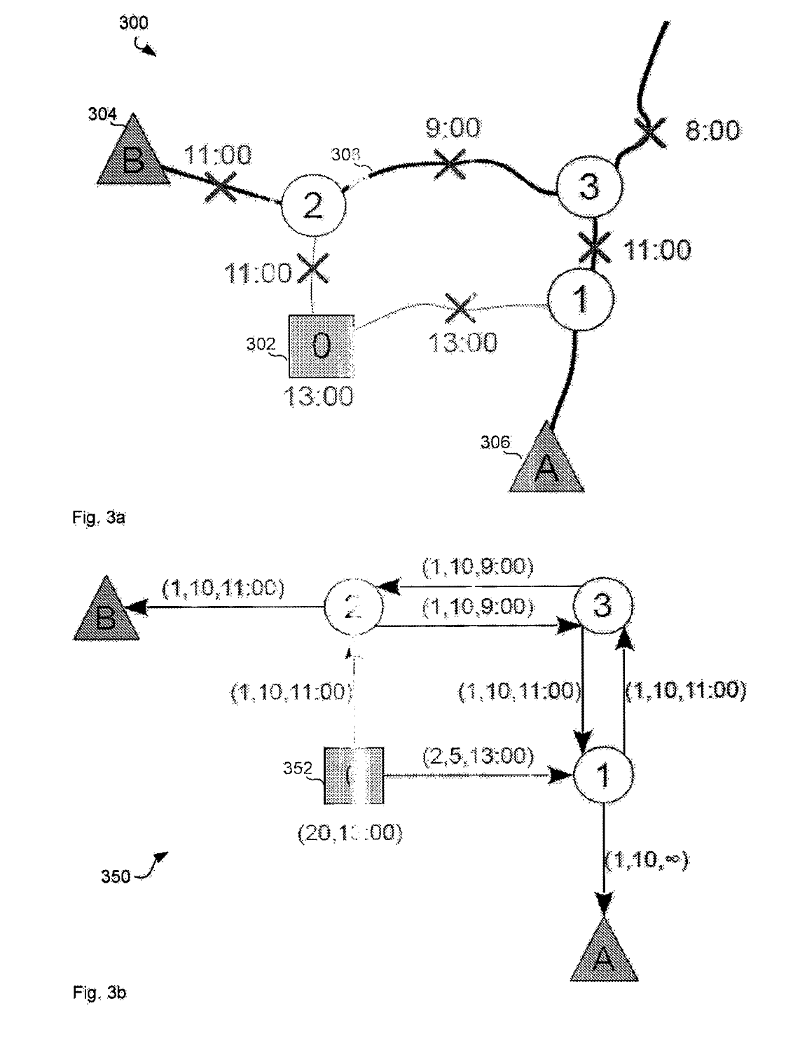

FIG. 3a illustrates a general evacuation scenario 300. FIG. 3a presents an evacuation scenario with one evacuated node 302 and two safe nodes 304 and 306. In this example, the evacuated node 302 has to be evacuated by 13:00, considering that certain links become unavailable at different times (for instance, 2-3 edge 308 is cut at 9:00).

FIG. 3b illustrates how the evacuation, scenario of FIG. 3a can be represented as a graph 350 [symbol] =( [symbol] =ε∪ [symbol] ∪S, [symbol] ) where ε, [symbol] , and S are the set of evacuated, transit, and safe nodes respectively, and [symbol] is the set of edges. Each evacuated node i is characterized by a number of evacuees dᵢ and an evacuation deadline f̅ᵢ (e.g., 20 and 13:00 for node 0 (reference numeral 352) respectively), while each edge e is associated with a triple (sₑ,uₑ,f̅ₑ), where sₑ is the travel time. uₑ is the capacity, and f̅ₑ is the time at which the edge becomes unavailable.

FIG. 4 illustrates a temporal discretisation graph 400 of the planning horizon. One way to deal with the space-time aspects of evacuation problems is to discretize the planning horizon into time steps of identical length, and to work on a time-expanded graph 400, as illustrated in FIG. 4. This graph 400 [symbol] ^{d}=( [symbol] ^{d}=ε^{d}∪ [symbol] ^{d}∪S^{d}, [symbol] ^{d}) is constructed by duplicating each node from [symbol] for each time step. For each edge (i,j∈ [symbol] and for each time step t in which edge (i,j) is available, an edge ( [symbol] ) is created modeling the transfer of evacuees from node i at time t to node j at time [symbol] .

In addition, edges with infinite capacity are added to model the evacuees waiting at evacuated and safe nodes. Finally, all evacuated nodes (resp. safe nodes) are connected to a virtual super-source v [symbol] (super-sink v [symbol] ), modeling the inflow (outflow) of evacuees. Note that some nodes may not be connected to either the super-source or super-sink (in light gray in this example), and can therefore be removed to reduce the graph size. The problem is then to find a flow from v [symbol] to v [symbol] that models the movements of evacuees in space and time.

In one example, the following assumptions are made:
1. A central decision maker 116 instructs each evacuee when to leave, which safe node to go to, and which path to follow in the evacuation graph;
2. A single threat scenario is known at decision time;
3. The central decision maker's 116 objective is to evacuate as many persons as possible and to delay the evacuation decision as much as possible until more accurate threat scenarios are available;
4. Each evacuated node should be assigned to a single evacuation path;
5. Edges capacity does not depend on the flow, and no congestion occurs at intersections.

Assumption 1 relates to examples where the proposed approach is targeted toward emergency or safety services that need to design evacuation plans for buildings or regional areas. Assumption 2 and 3 correspond to threats for which forecast or scenarios are available in advance. Example of such threats include hurricanes, forest fires, floods, or industrial hazards.

Assumption 4 is a practical consideration and reflects the practice in emergency services operations. Finally, assumption 5 is a necessary simplification to solve the models efficiently, and it is compensated by the fact that edge capacities are set to ensure non-congested traffic conditions. In that context, the problem is to design an evacuation plan that assigns a single evacuation path to each evacuated node, and to schedule the evacuation over the planning horizon, with the objective of first maximizing the number of evacuees reaching a safe node, and then optimising the quality of the evacuation schedule, such as by delaying the evacuation as much as possible.

To address the issue of complexity, method 200 follows a conflict-based heuristic column generation approach (CG) that separates the generation of evacuation paths from the scheduling of the evacuation.

Method 200 commences by the processor 102 receiving an initial set of paths Ω′ for the multiple groups to move through the transport network to respective arrival locations, such as safe zones. In one example, the initial set of paths Ω′ is generated by processor 102 or other means and stored on data store 106 from where the processor 102 receives it via a memory interface. The processor 102 further, receives 204 an initial departure schedule and initial path for each group. The processor 102 may determine the initial departure schedule and initial path by solving a master scheduling problem to find an evacuation schedule that maximizes the number of evacuees reaching safety. This means solving the master problem determines for each group a path to the respective safe zones and a departure schedule. The processor then receives the result via a memory interface as described earlier.

In one example, the departure schedule comprises a departure time for each evacuee, where the departure time may be the same or different, for each evacuee of the same group. In other examples, the departure schedule comprises more detailed timing information for each evacuee, such as a travel itinerary including arrival times at the safe node.

In one example, the processor 102 determines the five shortest, paths through the transport network as the initial set of paths. The processor 102 then solves the master scheduling problem formulated as a mixed integer problem (MIP). Solving this master problem involves minimising or maximising a cost function while satisfying certain constraints. The solution of the master scheduling problem is an initial path and an initial departure schedule for each group. In examples described further below, the solution of the master scheduling problem also comprises an updated network configuration.

In one example, the solution includes exactly one path per group, which means that the initial path and the updated path are the same for all evacuees of each group. In other examples, however, more than one paths, such as two or three paths, are also possible.

The processor 102 then simulates the movements of the evacuees leaving their respective evacuation nodes according to the initial departure schedule and traveling to the safe nodes following the respective initial paths. In one example, the simulation is based on the departure schedule produced by the master problem. In another example, the simulation is based on MATSIM (http://www.matsim.org), a traffic simulation software package to simulate the actual movements of evacuees.

The results of the simulation allow the processor 102 to determine 206, that is, identity critical groups. In one examples, critical groups are groups which are not fully evacuated, or evacuated early. This information is later used to generate and add 208 new paths. Finally the master scheduling problem is solved 210 again but including the newly generated paths. The last steps 206, 208 and 210 are repeated for a given number of iterations, until a predefined number of non-improving iterations has been reached, or any other criterion guided by operational considerations (e.g., real-time response).

As mentioned earlier, the master scheduling problem can be solved using a mixed integer program. Let Ω be the set of all feasible paths between evacuated nodes and safe nodes and Ωₖ be the subset of evacuation paths for evacuated, node k. We define a binary variable xₚ which takers the value of 1 if and only if path p∈Ω is selected, a continuous variable φₚ representing the flow of people, that is, the number of evacuees to start evacuating on path p at departure time t, and a continuous variable φ [symbol] accounting for the number of non-evacuated evacuees in node k. In addition, we denote by Ω(e) the subset: of paths that contain edge e and by τ [symbol] the number of time steps required to reach edge e when following path p. Finally, we note: [symbol] ₚ⊂ [symbol] the subset of time steps in which path p is usable, and uₚ the capacity of path p defined as the minimum of the edge capacites along path p, that is, the bottleneck capacity.

The master scheduling problem CG-MP maximizing the number of evacuees reaching a safe zone can be formulated as follows:

$$\begin{matrix} max {\sum }_{p ∈ Ω} {\sum }_{\text{?}} {ϕ}_{p}^{′} & ( 1 ) \\ s . t . {\sum }_{p ∈ {Ω}_{k}} {x}_{p} = 1 \\ ∀ k ∈ ℰ & ( 2 ) \\ {\sum }_{p ∈ {Ω}_{k}} {\sum }_{\text{?}} {ϕ}_{p}^{′} + {ϕ}_{k} = {d}_{k} \\ ∀ k ∈ ℰ & ( 3 ) \\ {\sum }_{p ∈ ω ( c )} \text{?} \leq {u}_{e} \\ ∀ e ∈ A , t ∈ ℋ & ( 4 ) \\ \text{?} {ϕ}_{p}^{t} \leq \vert {ℋ}_{p} \vert {x}_{p} {u}_{p} \\ ∀ p ∈ Ω & ( 5 ) \\ \text{?} \geq 0 \\ ∀ p ∈ Ω , t ∈ {ℋ}_{p} & ( 6 ) \\ {ϕ}_{k} \geq 0 \\ ∀ k ∈ ℰ & ( 7 ) \\ {x}_{p} ∈ [ 0 , 1 ] \\ ∀ p ∈ Ω \\ \text{?} \text{indicates text missing or illegible when filed} & ( 8 )\end{matrix}$$

The objective (1) maximizes the total flow of evacuees, which is equivalent to the number of evacuees reaching safety. Constraints (2) ensure that exactly one path is selected for each evacuated node, while constraints (3) account for the number of evacuated and non-evacuated evacuees. Constraint (4) enforce the capacity on the edges of the graph. Finally, constraints (5) ensures that there is no flow on paths that are not selected. In practice, we only consider a subset of evacuation paths Ω′⊂Ω each time we solve the scheduling master problem CG-MP. Once the master problem is formulated in a standard way, solving the master problem may be performed by a third party software package, such as the Gurobi Optimizer (http://www.gurobi.com/). Solving the master problem that way simultaneously determines the departure schedule and the path for each group.

In a linear model, the set of variables and constraints define a matrix A (we generally note a model as min c^{τ}xs [symbol] .Ax=b, where c, b, and x are vectors). The larger the number of elements in A, the more computational effort is required by the optimisation algorithm. Note that a formulation of the evacuation planning and scheduling problem as a multi-commodity flow (not detailed here) would imply a matrix A with billions of elements.

The approach we propose switches the perspective, and dramatically reduces the number of variables, and as a direct consequence, reduces the size of A. This matrix reduction reflects a more sophisticated modelling approach that results in a speed-up of the solving algorithm. The optimisation is not performed on the complete set of edges (connecting roads) defined by the road network. Instead, the optimization aggregates the decisions and only considers the number of evacuees starting evacuating at a given time step and following a given path. Each path comprises a number of edges, and the flow of evacuees on each of these edges can be fully described with the inflow of evacuees on the path. As a result, the flow variables are defined on a subset of the complete set of edges and the overall number of variables (columns of A) is reduced.

In addition, the size of matrix A is reduced with respect to the considered time steps. For example, the decision maker 116 may define earliest and latest departure time for each group, and depending on the threat scenario, a subset of edges may become unavailable after a certain time. As a consequence, we restrict the possible schedules by not considering departure times that will violate these constraints, which leads to a further reduction in the number of columns of A.

When the master scheduling problem (1-8) is formulated for all possible paths, it contains an exponential number of columns. In the worst case (i.e., if the graph G 200 is fully connected), Ω contains |E|2^{|T+S|} paths, which is equivalents to billions of columns even for small networks, and therefore impossible to solve in practice. Hence, the approach we propose does not explicitly consider all the paths from Ω, but instead iteratively generates a subset of paths Ω′ by adding paths to an initial set of paths, and solves a reduced master scheduling problem multiple times.

FIG. 5 is an abstract representation of the matrix A of the master scheduling problem in the proposed formulation. Each row is a constraint (or set of constraints) and each column is a variable, itself associated with an evacuation path. The shaded area corresponds to the variables associated with the evacuation paths generated so far. The non-shaded areas correspond to the variables associated with evacuation paths that have not yet been generated (and may never be generated). The constraints (5) are associated with each path and must also be dynamically added to the model at each iteration. Note that each constraint from (5) will involve all the variable associated with the associated path, as illustrated by the solid lines in the matrix.

Each path corresponds to multiple columns and introduces a new constraint. Processor 102 uses conflict-based heuristic column generation which relics on problem-specific knowledge to generate new columns that will potentially improve the objective function of the master problem. First, processor 102 identifies the subset ε′⊂ε of critical evacuated nodes, for instance, nodes that are not fully evacuated in the current solution. Then, processor 102 includes in ε′ all the evacuated nodes whose evacuation paths share at least one edge with a node from ε′. Finally, processor 102 generates new paths for the critical evacuated nodes ε′ by solving the following multiple-origins, multiple-destinations shortest path problem:

$$\begin{matrix}min {\sum }_{k ∈ ℰ} {\sum }_{e ∈ 𝒜} {c}_{e} {y}_{e}^{k} & ( 9 ) \\ s . t . {\sum }_{e ∈ {δ}^{-} ( i )} {y}_{e}^{k} - {\sum }_{e ∈ {δ}^{+} ( i )} {y}_{e}^{k} = 0 \\ ∀ i ∈ 𝒯 , k ∈ ℰ & ( 10 ) \\ {\sum }_{e ∈ {δ}^{+} ( k )} {y}_{c}^{k} = 1 \\ ∀ k ∈ ℰ & ( 11 ) \\ {y}_{c}^{k} ∈ \{ 0 , 1 \} \\ ∀ k ∈ ℰ , e ∈ 𝒜 & ( 12 )\end{matrix}$$

where y^{k}ₑ is a binary variable raking the value of 1 if and only if edge e belongs to the path generated tor evacuated node k, and cₑ is the cost assigned to edge e. In order to generate diverse evacuation paths, the cost cₑ of edge e is adjusted at each iteration using a linear combination of the edge's travel time, the number of occurrences of e in the current set of paths, and the utilization of e in the current solution.

In some examples, stakeholders are also interested in delaying the evacuation as much as possible. This is motivated by the fact that, as the disaster unfolds, more information is available on the nature, extent, and timing of the threat, tor instance with more accurate weather forecasts.

Processor 102 employs an implicit method that maximizes the number of evacuees reaching safety and schedules the evacuation in a single step. With the purpose of modelling non-evacuated evacuees, we add an edge between the last time-copy of each evacuated node and the super-sink, with zero travel tints and infinite capacity. The scheduling of the evacuation is achieved by associating, with edges leaving an evacuated node, a penalty inversely proportional to the time slice in which they belong.

Formally, we define a penalty cost for each time step as c [symbol] =(H− [symbol] )lH and c [symbol] a high penalty for non-evacuated evacuees. The Implicit evacuation, scheduling problem CG-MP model (CG-I) minimizes the total cost of the flow for all paths and is defined as follows:

$$min {\sum }_{k ∈ C} {ϕ}_{e} {c}_{re} + {\sum }_{p ∈ Ω} {\sum }_{c ∈ {ℋ}_{p}} {ϕ}_{r}^{p} {c}^{y} \qquad ( 13 )$$

The constraints for optimising this objective function (13) are the same constraints (2)-(8) as above.

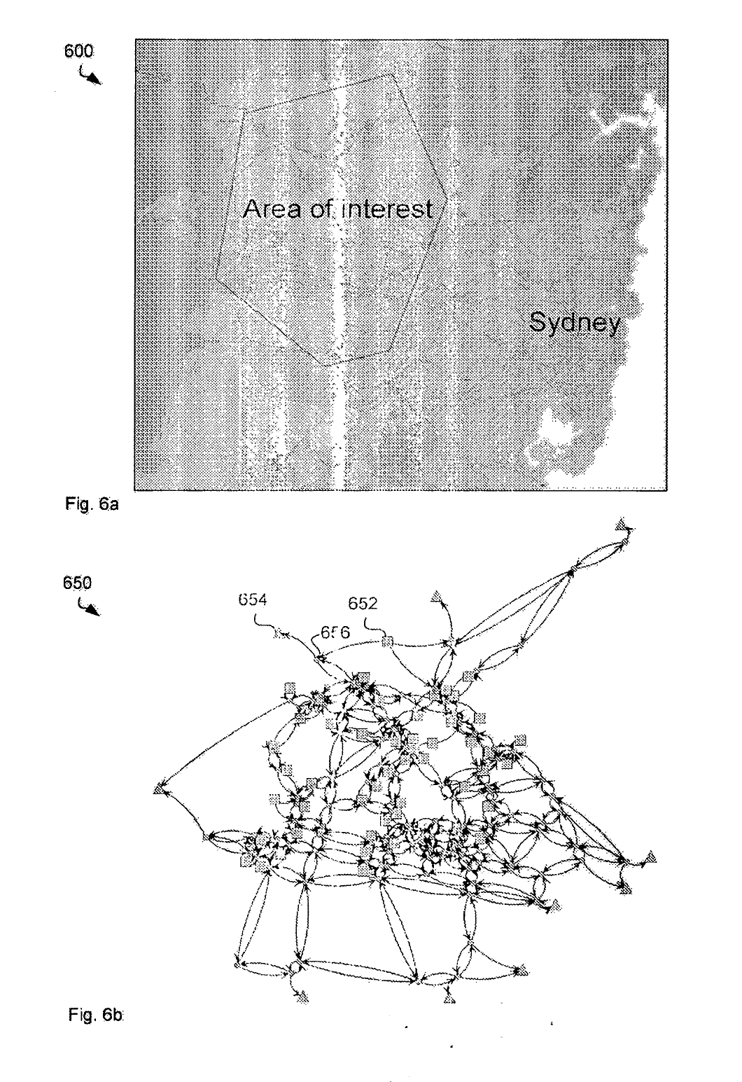

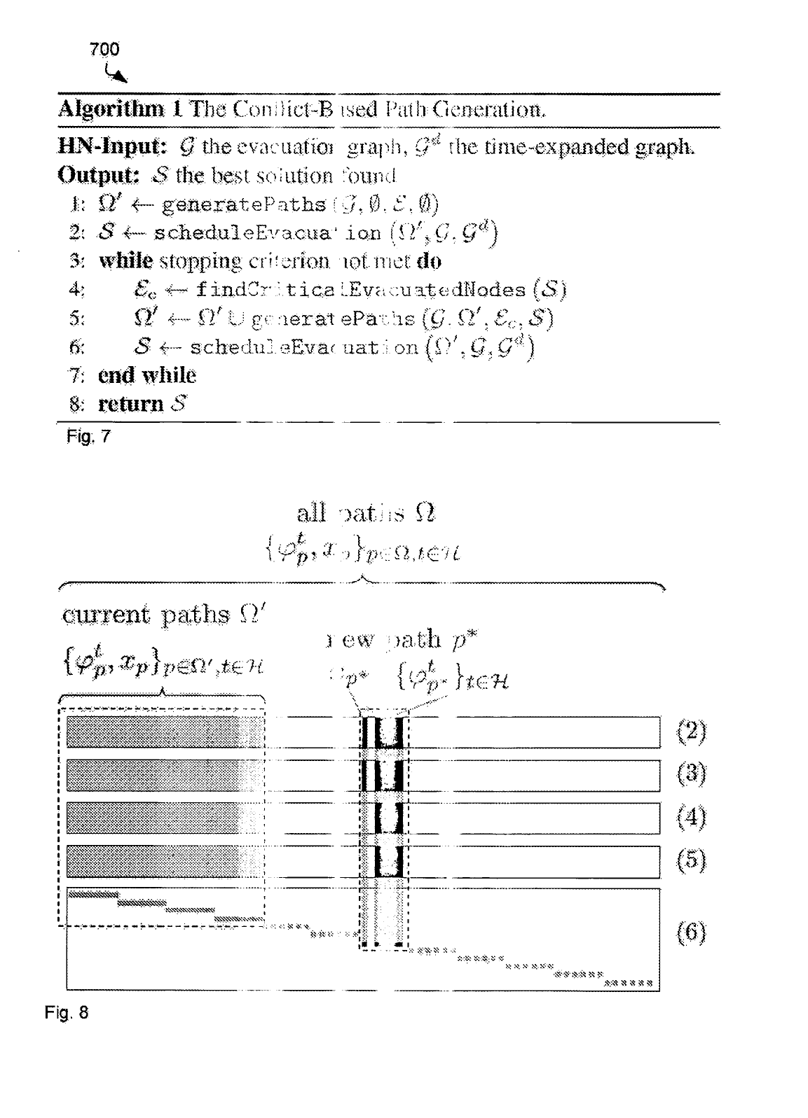

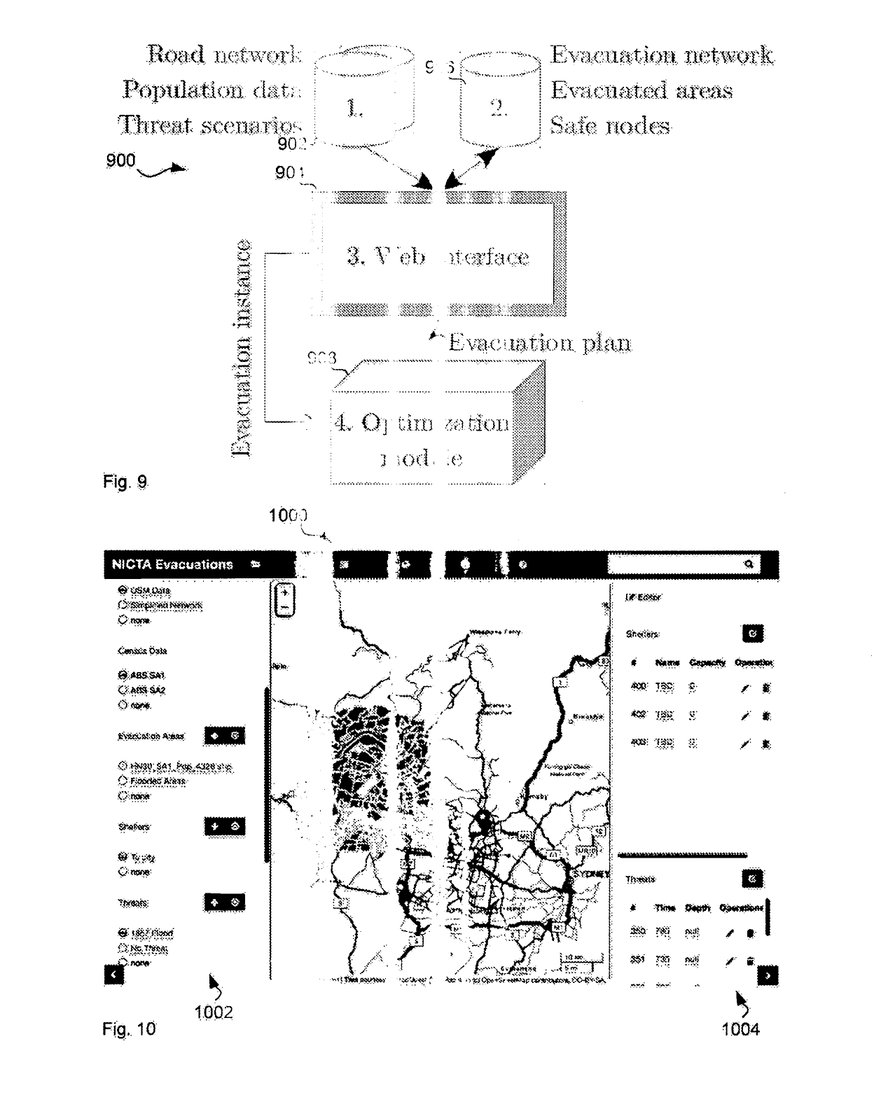

In one example, the above method is applied, to the evacuation of the Hawkesbury-Nepean (HN) floodplain, located Northwest of Sydney (see FIG. 6a), for which a 1-in-200 years flood would require the evacuation of 70,000 persons.

FIG. 6a illustrates a map 600 of the geographical area of interest and FIG. 6b illustrates the corresponding evacuation graph 650 for the HN floodplain. The evacuation graph 650 contains 50 evacuated nodes, such as node 652, 10 safe nodes, such as node 654, 125 transit nodes, such as node 656, and 458 edges. In this example, processor 102 considers a horizon of 18 hours with a time step of 5 minutes (starting at 00h00). The evacuation deadlines and times at which edges are cut were derived from a flooding scenario similar to the historical 1867 flood.

In. one example, method 200 of FIG. 2 is implemented using Java 7 and Gurobi 5.1.1 on an Ubuntu 12.04 64 bits machine with a 2.4 Ghz 8-cores Intel Xeon processor and 32 Gb of RAM. Results are an average over 10 runs given the randomized nature of parts of the algorithm and in particular Gurobi.

In the example of the HN floodplain scenario there is a dramatic reduction in model size that the described approach provides, with a number of columns reduced, from 4.4 millions to 32 thousands, and a number of constraints reduced from 5.7 millions to 79 thousands when compared with a multi-commodity flow approach. This allows the method 200 to plan and schedule the evacuation of more than 35,000 vehicles in under 30 seconds.

In one example, the processor 102 has a further input port (not shown) to receive events related to the transport network, such as roads closures, threat scenario updates and traffic information. The processor 102 then updates the road network, such as by adjusting the capacity of affected edges where the speed of travel is reduced or removing edges altogether. The processor 102 then performs the method described above to design an evacuation, plan over the changed network. The processor 102 may start from the previous solution based on the outdated road network as an initial solution or may start from a new initial solution as described above. The re-computation of the evacuation plan in response to changes to the road network may be in real-time, that is, the evacuation plan is continuously adjusted and each adjustment is computed within a set maximum computation time.

This disclosure considers evacuation planning and scheduling, a critical aspect of disaster management and national security applications. It proposes a conflict-based heuristic column-generation approach whose key idea is to generate evacuation paths for evacuated areas iteratively and optimize the evacuation over these paths in a master problem. Each new path is generated to remedy conflicts in the evacuation and adds new columns and a new row in the master problem.

The following description provides further examples that may have slight variations from the examples above or may have large parts in common.

Examples in this disclosure combine actionable evacuation plans, which provide an evacuation path and departure time to each evacuee, evacuation staging, which distributes the load on the network over time, and contraflow selection for roads. In addition, the optimization models are integrated in an evacuation Planner, a web-based intelligent system for evacuation. The result is an integrated tool that provides a wide array of functionalities to evacuation planners and produces high-quality evacuation plans.

FIG. 7 illustrates another example for an algorithm 700 for the CPG approach. In one example, both the original (CPG) and contraflow (CPC-CF) approaches rely on the structure described in algorithm 700. They share the same path generation procedure, but have different master scheduling problems, referred to as CPG-MP and CPG-CF-MP respectively.

As explained above with reference to FIG. 3b, an evacuation scenario can be represented as a graph 350 [symbol] =( [symbol] =ε∪ [symbol] ∪S, [symbol] ) where ε, [symbol] , and S are the set of evacuated, transit, and safe nodes respectively, and [symbol] is the set of edges. In one example, Aᵢ⊂A is the subset of edges that can be used in contraflow. Aᵢ may contain major roads and one-way streets.

In one example, processor 102 finds, for each node from ε [symbol] the shortest path to any safe node in the evacuation graph [symbol] . In other words, it transforms a multi-commodity flow problem in the time-expanded graph into a series of shortest paths in the evacuation graph, relaxing the edge-capacity constraints in the form of a penalty in the objective function. More specifically, the cost cₑ^{SP} of edge e is adjusted at each iteration using the linear combination of the edge travel time sₑ, the number of occurrences of e in the current set of paths Ω, and the utilization of e in the incumbent solution:

$${c}_{e} = {α}_{t} \frac{{s}_{e}}{{max}_{\text{?}} {s}_{e}} + {α}_{c} \frac{{\sum }_{\text{?}} 1}{\vert Ω \vert} + {α}_{u} \frac{{\sum }_{\begin{matrix}p ∈ Ω \\ p ∈ p\end{matrix}} {\sum }_{t ∈ {ℋ}_{p}} \text{?}}{{u}_{c}} \\ \text{?} \text{indicates text missing or illegible when filed} \qquad ( 14 )$$

where αᵢ, a_{c}, and αₑ are positive weights summing to 1.

A further formulation of the master problem described above with reference to equations (2) to (8) is now provided.

$$\begin{matrix} min {\sum }_{k ∈ ℰ} {ϕ}_{k} {c}_{e} + {\sum }_{p ∈ Ω} {\sum }_{p ∈ {ℋ}_{p}} \text{?} & ( 15 ) \\ s . t . {\sum }_{p ∈ {Ω}_{k}} {x}_{p} = 1 \\ ∀ k ∈ ℰ & ( 16 ) \\ {\sum }_{p ∈ {Ω}_{k}} {\sum }_{p ∈ {ℋ}_{p}} {ϕ}_{p}^{t} + {ϕ}_{k} = {d}_{k} \\ ∀ k ∈ ℰ & ( 17 ) \\ {\sum }_{\text{?}} \text{?} \leq {u}_{e} \\ ∀ e ∈ 𝒜 , t ∈ ℋ & ( 18 ) \\ {\sum }_{s ∈ {ℋ}_{p}} {ϕ}_{p}^{t} \leq \vert {ℋ}_{p} \vert {x}_{p} {u}_{p} \\ ∀ p ∈ Ω & ( 19 ) \\ {ϕ}_{p}^{ι} \geq 0 \\ ∀ p ∈ Ω t ∈ {ℋ}_{p} & ( 20 ) \\ {ϕ}_{k} \geq 0 \\ ∀ k ∈ ℰ & ( 21 ) \\ {x}_{p} ∈ \{ 0 , 1 \} \\ ∀ p ∈ Ω \\ \text{?} \text{indicates text missing or illegible when filed} & ( 22 )\end{matrix}$$

Model (15-22) presents the master scheduling problem CPG-MP. The objective (15) minimizes the cost of the solution as defined previously. Constraints (16) ensure that exactly one path is selected for each evacuated node, while constraints (17) account for the number of evacuated and non-evacuated evacuees. Constraints (18) enforce the capacity on the edges of the graph. Finally, constraints (19) ensure that there is no flow on paths that are not selected.

FIG. 8 illustrates the structure of the MP problem as stored on data memory 106 and highlights a specificity of the MP model: each new path p [symbol] adds it binary variable x [symbol] ,

a set of continuous variables φ [symbol] , and a set of constraints (19). For this reason, traditional column generation approaches are difficult to be used to generate new paths. In this example, the master problem does not use a variable for each edge e and time step t, but relies on variables φ [symbol] . This can greatly reduce the number of variables, and changes the structure of the MP.

Like in CPG-MP, solving the contraflow roaster scheduling Problem (CPG-CF-MP) processor 102 assigns paths to evacuated nodes, and then schedules the evacuation. However, the two models differ in the way the edge capacity is modelled.

Considering that the evacuation graph is directed and contains at most one edge between two nodes in each direction, we define ē as the unique edge going in the opposite direction of edge e∈ [symbol] . In addition, we define an arbitrary partition A_{c}={A_{c}⁺|A_{c}⁻} such that ∀e∈A_{c}⁺,ē∈A_{c}⁻. In order to control the contraflows, we create a binary variable x [symbol] for edge e∈ [symbol] [symbol] equal to 1 if edge e is used in its normal direction. With this definition, there are three possible configuration (x_{z,999} ,x_{z,999} ) for a road segment (e,ē): (1,1) if both edges are used in their normal direction, (1,0) if edge ē is in contraflow, (0,1) if edge e is in contraflow:

$$\begin{matrix} min {\sum }_{k ∈ ℰ} {ϕ}_{k} {c}_{ne} + {\sum }_{p ∈ Ω} {\sum }_{t ∈ {ℋ}_{p}} {ϕ}_{p}^{t} {c}_{p}^{t} \\ s . t . & ( 23 ) \\ {\sum }_{p ∈ {Ω}_{k}} {x}_{p} = 1 \\ ∀ k ∈ ℰ & ( 24 ) \\ {\sum }_{p ∈ Ω} {\sum }_{t ∈ {ℋ}_{p}} {ϕ}_{p}^{t} + {ϕ}_{k} = {d}_{k} \\ ∀ k ∈ ℰ & ( 25 ) \\ {\sum }_{\text{?}} \text{?} \leq {u}_{e} \\ ∀ e ∈ 𝒜 \backslash {𝒜}_{c} , t ∈ ℋ & ( 26 ) \\ {\sum }_{t ∈ {ℋ}_{p}} {ϕ}_{p}^{t} \leq \vert {ℋ}_{p} \vert {x}_{p} {u}_{p} \\ ∀ p ∈ Ω & ( 27 ) \\ {\sum }_{\text{?}} ϕ \text{?} \leq {x}_{q} {u}_{e} + ( 1 - {x}_{\overline{e}} ) {u}_{\overline{e}} \\ e ∈ {𝒜}_{c} , t ∈ ℋ & ( 28 ) \\ {x}_{e} + {x}_{\overline{e}} \geq 1 \\ ∀ e ∈ {A}_{e}^{+} & ( 29 ) \\ {x}_{s} \geq {x}_{p} \\ ∀ e ∈ {𝒜}_{c} , ∀ p ∈ ω ( e ) & ( 30 ) \\ {x}_{p} ∈ \{ 0 , 1 \} , {ϕ}_{p}^{s} , {ϕ}_{k} \geq 0 \\ ∀ p ∈ {Ω}_{+} k ∈ ℰ , t ∈ {ℋ}_{p} \\ \text{?} \text{indicates text missing or illegible when filed} & ( 31 )\end{matrix}$$

Model (23-31) details the contraflow master scheduling problem CPG-CF-MP. Constraints (24-26) are identical to (16-18) in CPG-MP. Constraints (28) enforce the capacity on edges that allow contraflow. They allocate to e the capacity of edge ē whenever ē is used in contraflow, and forbid any flow on e when it is used in contraflow. Constraints (29) prohibit the simultaneous use of e and ē in contraflow. Finally constraints (30) force the use of the edges in any selected path.

Since the variables xₑ are used in the optimisation problem, processor 102 determines which edges allow contraflow when solving the problem. It is further noted that the variables xₑ describe a network configuration, that is: a configuration which edges are configured to allow contraflow. In one example, these variables are initialised to not allowing contraflow and by solving the optimisation problem, processor 102 determines an updated network configuration where some edges allow contraflow, that is, the binary variables are changed from ‘1’ to ‘0’.

Determining the network configuration may consist in deciding a set of edges that can be used in contraflow, or similarly which road lanes should be used in reversed direction to maximise the network capacity.

In this model, the contraflows and their directions remain the same for the entire evacuation. In theory, changing the sense of contraflows could be useful when evacuating an area threatened by a disaster with unpredictable expansion. Bushfires, for instance, are highly dependent on wind conditions and a variation in wind direction may change the direction of the fire without notice. In practice though, contraflows require significant coordination efforts and it does not appear desirable to change the direction of lanes over time.

The set of edges allowing contraflow [symbol] ₙ may be decided prior to computation. Based on the consideration that authorities in charge of the evacuation can monitor contraflow lane reversals only on a few portions of roads, we decided to allow contraflow on the road sections that are the most likely to make the evacuation quicker. Those roads may be main roads such as highways and freeways with a great capacity and a shorter travel time. Beyond the fact that it is not practical to implement contraflow on every road section due to a limited number of resources, the benefit of using contraflows on secondary roads is rather limited as they have a lower contribution to the network outflow capacity. In fact, the major roads may the bottlenecks as they collect traffic from a number of evacuated areas to specific safe zones.

FIG. 9 presents an Evacuation Planner computer system 900, an intelligent system for integrated evacuation planning. Computer system 900 pulls information from raw databases 902 containing the detailed road network (e.g., via Open Street Maps), population census, threat scenarios, and preprocesses the data to display it to the planners via a web interface 904. Planners are able to manipulate the data and define the evacuation network (which can be a simplified or reduced version of the road network). Planners can then specify the areas that need to be evacuated, as well as the safe areas and shelters. This information is saved in a second database 906 and can be combined to produce an evacuation instance which is then used as input to the evacuation optimization module 908. The resulting evacuation plans are then presented to the planner who can then iterate the process, refining the selection of residential zones, evacuation roads, contraflow edges, and threat scenarios.

FIG. 10 illustrates a web interface which allows planners to work with multiple scenarios simultaneously. A left panel 1002 presents the different layers (e.g., road network, population, evacuated areas), while a right panel 1004 provides editing functionalities.

Two case studies are presented here to assess the quality and performance of the disclosed methods. The first is the Hawkesbury-Nepean (HN) floodplain, located North-West of Sydney, for which a 1-in-200 years flood would require the evacuation of 70,000 persons (approximately 38,000 vehicles). The evacuation graph contains 80 evacuated nodes, 6 safe nodes, 191 transit nodes, and 604 edges. The algorithms consider a time horizon of 10 hours with a time step of 5 minutes (starting at 00h00).

The HN-Ix instances share the same evacuation graph but the number of evacuees is scaled by a factor of x∈[1.1,3.0].

The second case study is the New Orleans Metropolitan Area (NO), which is threatened by hurricanes of category 2 or more every 3 years on average. Stronger hurricanes such as Katrina in 2005 require the evacuation of more than 1 million people (approximately 400,000 vehicles). The evacuation graph in this case study contains 323 evacuated nodes, 5 safe nodes, 1493 transit nodes, and 3606 edges. The algorithms consider a time horizon of 72 hours divided in time steps of 20 minutes.

In one example, the methods are implemented using Java 7 and Gurobi 5.5. Computations may be conducted on a cluster of 64 bits machines with 2.8 GHz AMD 6-Core Opteron 4184 and 16 Gb of RAM. The path generation method may use Dijsktra's algorithm to compute the shortest paths. Both CPG and CPG-CF may have a limit of 10 iterations.

It only takes 5 hours and 34 minutes to evacuate the population for the whole Hawkesbury-Nepean region with CPG-GF compared to a total evacuation time of 8 hours for CPG. In addition, CPG-CF is able to evacuate 91% of vehicles in the HN region in 10 hours when the population is increased by 200%, whereas CPG only evacuates 12% of the vehicles.

The total number of paths generated is consistent across instances, with an average of 1,066 paths, which correspond to 100 paths per iteration. The variance is explained by the generation of duplicate paths that are discarded. The results also indicate that the numbers of columns and rows vary with the instance. This is due to the fact that processor 102 uses the incumbent solution to discard variables that would lead to a longer evacuation time. Therefore the size of the MP decreases with the evacuation time in the incumbent solution. The CPG-CF model consistently evacuates more persons in less time, which in turns translate into fewer columns and rows in the model, and average computational times lower than CPG, despite a larger number of binary variables a priori.

It will be appreciated by persons skilled in the art that numerous variations and/or modifications may be made to the specific embodiments without departing from the scope as defined in the claims.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the Internet.

It should also be understood that, unless specifically stated otherwise as apparent from the following discussion, it is appreciated that throughout the description, discussions utilizing terms such as “receiving” or “estimating” or “processing” or “computing” or “calculating” or “generating”, “optimizing” or “determining” or “displaying” or “maximising” of “equalising” or the like, refer to the action and processes of a computer system, or similar electronic computing device, that processes and transforms data represented as physical (electronic) quantities within the computer system's registers and memories into other data similarly represented as physical quantities within the computer system memories or registers or oilier such information storage, transmission or display devices.

1. A method for planning movement of multiple groups over a transport network, the method comprising:
receiving an initial set of paths for the multiple groups to move through the transport network to respective arrival locations;
receiving for each group an initial path to the respective arrival location and an initial departure schedule;
determining based on the initial departure schedules and initial paths one or more critical groups that violate a movement performance threshold;
determining based on the transport network an updated set of paths by adding one or more paths for each critical group to the initial set of paths; and
determining for each group an updated path to the arrival location and an updated departure schedule based on the updated set of paths.

2. The method of claim 1, wherein the movement is an evacuation.

3. The method of claim 1, wherein the transport network is a road network.

4. the method of claim 1, wherein each of the multiple groups comprises multiple group members and for each of the multiple groups the initial path and updated path are the same for all members of that group.

5. The method of claim 1, wherein each of the multiple groups is associated with a geographical zone and the initial path and the updated path start from the geographical zone of the respective group.

6. The method of claim 1, further comprising repeating the steps of determining the critical groups, determining the updated set of paths and determining the updated departure schedule and updated path to iteratively optimise the updated departure schedule and the updated path.

7. The method of claim 6, wherein to iteratively optimise comprises to maximise a flow of group members to the arrival locations.

8. The method of claim 6, wherein to iteratively optimise is such that the updated departure schedule and the updated path satisfy one or more constraints.

9. The method of claim 8, wherein the one or more constraints are defined by multiple variables, such that the number of variables is based on the number of paths in the updated set of paths.

10. The method of claim 8, wherein the one or more constraints are defined by one or more variables for each of multiple time steps.

11. The method of claim 1, wherein determining the updated departure schedule and the updated set of paths comprises simultaneously determining the updated departure schedule and the updated set of paths.

12. The method of claim 11, wherein simultaneously determining the updated departure schedule and the updated path comprises solving a mixed integer programming problem.

13. The method of claim 12, wherein the mixed integer programming problem is based on a flow of group members as a continuous variable.

14. The method of claim 1, wherein determining the critical groups comprises simulating the movement over the initial paths of the multiple groups based on the respective initial departure schedules.

15. The method of claim 1, further comprising:
receiving events related to the transport network;
determining an updated transport network based on the events; and
performing the method of any one of the preceding claims based on the updated transport network.

16. The method of claim 1, wherein adding one or more paths for each critical group comprises determining the one or more paths by solving a multiple-origin multiple-destination shortest path problem.

17. The method of claim 1, wherein:
determining the one or more critical groups comprises determining the one or more critical groups based on an initial configuration of the transport network, and
the method further comprises determining an updated network configuration.

18. The method of claim 17, wherein determining the updated departure schedule, the updated path and the updated network configuration comprises simultaneously determining the updated departure schedule, the updated path and the updated network configuration.

19. The method of claim 1, wherein the initial set of paths and the updated set of paths comprise multiple edges; and the initial network configuration and the updated network configuration comprise configuration data indicative of whether one or more of the multiple edges is configured to allow contraflow.

20. The method of claim 19, wherein
the initial set of paths and the updated set of paths each comprise two edges in opposite direction between each of multiple nodes, and
the configuration data is indicative of whether one of the two edges is configured to allow contraflow.

21. A non-transitory computer readable medium, including computer-executable instructions stored thereon that when executed by a processor, causes the processor to perform the method of claim 1.

22. A computer system for planning movement of multiple groups over a transport network, the computer system comprising:
a first input port to receive an initial set of paths for the multiple groups to move through the transport network to respective arrival locations;
a second input port to receive for each group an initial departure schedule and an initial path to the respective arrival location; and
a processor
to determine based on the initial departure schedules and initial paths one or more critical groups that violate a movement performance threshold,
to determine based on the transport network an updated set of paths by adding one or more paths for each critical group to the initial set of paths; and
to determine for each group an updated departure schedule and an updated path to the arrival location based on the updated set of paths.
